(19) United States
(12) Patent Application Publication
(10) Pub. No.: US 2011/0187864 A1
(43) Pub. Date: Aug. 4, 2011

(54) SITE SURVEILLANCE FOR REMOTE MONITORING ON PORTABLE DEVICES

(75) Inventor: Eric J. Snider, Peoria, AZ (US)

(73) Assignee: Eric J. Snider, Peoria, AZ (US)

(21) Appl. No.: 12/697,157

(22) Filed: Jan. 29, 2010

(51) Int. Cl. H04N 7/18; H04N 5/00

(52) U.S. Cl. 348/158; 348/E07.085; 386/E05.003

(57) ABSTRACT

Embodiments of site surveillance system for remote monitoring on portable devices are described. In one aspect, a system includes a data capture module, a communication module, and a surveillance server module. The data capture module is configured to capture images or sounds and generate electronic signals representative of the captured images or sounds. The communication module is configured to establish wireless communication with a portable device. The surveillance server module is communicatively coupled to the data capture module and the communication module, and is configured to receive the electronic signals as surveillance data from the data capture module, receive a request from the portable device via the communication module, and cause the surveillance data to be presented to a user by the portable device in response to the request from the portable device.

### BACKGROUND

In general, surveillance refers to the monitoring of activities or change in conditions in an environment or at a location. Surveillance systems may be employed by civilians or government agencies. In civilian applications, surveillance systems may be used to monitor the security and integrity of private premises. In governmental applications, surveillance systems may be used to monitor traffic, recognize and monitor threats, and prevent and/or investigate criminal activity.

Surveillance in today's world typically entails remote observation of a site, for example, from a distance by means of electronic equipment such as closed-circuit television (CCTV) cameras. The images, or footage, captured by the CCTV cameras may be viewed by a user of the surveillance system on a real-time basis as well as be recorded for later viewing and/or analysis. In order to view the captured images in real time, however, the user is typically required to be physically at a place where display equipment, such as one or more televisions connected to the CCTV camera(s), is located. Unfortunately, circumstances abound in which it is either difficult or impossible for someone, such as a law enforcement officer or a firefighter, to gain access to such display equipment to view CCTV camera footage to assess the situation at hand. For example, a police officer arriving at the entrance to a building in response to a 911 call is not likely to know the whereabouts of the display equipment of a surveillance system for the building. As another example, SWAT team members who try to rescue hostages being held by a mob inside a building may or may not have access to the building's surveillance system to assess the situation. It would be helpful if members of the SWAT team could also have knowledge of the building's floor plan and escape routes in addition to real-time surveillance data.

### SUMMARY

In one aspect, a surveillance system to monitor a site may include a data capture module, a communication module, and a surveillance server module. The data capture module may be configured to capture images, sounds, or images and sounds and to generate electronic signals representative of the captured images, sounds, or images and sounds. The communication module may be configured to establish wireless communication with a portable device. The surveillance server module is communicatively coupled to the data capture module and the communication module, and may be configured to receive the electronic signals as surveillance data from the data capture module, receive a request from the portable device via the communication module, and cause the surveillance data to be presented by the portable device to a user in response to the request from the portable device.

The data capture module may include a video camera that is adjustable via the surveillance server module in a number of aspects including pan, tilt, and zoom. The wireless communication between the communication module and the portable device may be in accordance with the Institute of Electrical and Electronics Engineers (IEEE) 802.11 standards, the IEEE 802.16 standards, Long Term Evolution (LTE), or a combination thereof.

The communication module may be further configured to function as a Dynamic Host Configuration Protocol (DHCP) server and additionally to provide DHCP option 6 to the portable device in response to receiving a DHCP address request from the portable device. Additionally or alternatively, the communication module may be further configured to function as a Hypertext Transfer Protocol (HTTP) server. Additionally or alternatively, the communication module may be further configured to support a Network Time Protocol (NTP) client to synchronize a clock in the communication module with a clock in the surveillance server module. Additionally or alternatively, the communication module may include a Global Positioning System (GPS) receiver to receive signals from a GPS satellite to provide time synchronization with the GPS satellite.

The surveillance server module may be communicatively coupled to the communication module in accordance with the IEEE 802.3 standards, the IEEE 802.11 standards, the IEEE 802.16 standards, LTE, or a combination thereof. The surveillance server module may be further configured to store the surveillance data.

The surveillance server module may be further configured to function as a DHCP server to assign an Internet Protocol (IP) address to the portable device, as a Domain Name System (DNS) server to map a domain name received from the portable device to an IP address of a default web page stored on the surveillance server module, and/or as an HTTP server to cause the surveillance data to be presented to the user via a web browser on the portable device.

The surveillance server module may be further configured to cause information related to the site to be presented by the portable device, where the information related to the site may include at least one of the following types of data: text, graphics, video and audio.

The surveillance server module may be further configured to support an NTP server to synchronize a clock in the surveillance server module with a clock in the communication module. The surveillance server module may include a GPS receiver to receive signals from a GPS satellite to provide time synchronization with the GPS satellite.

In another aspect, a surveillance system to monitor a site may include a data capture module, a communication module, and a surveillance server module. The data capture module may be configured to capture images, sounds, or images and sounds and to generate electronic signals representative of the captured images, sounds, or images and sounds. The communication module may be configured to establish wireless communication with a portable device. The surveillance server module may be communicatively coupled to receive the electronic signals as surveillance data from the data capture module and establish communication with the portable device via the communication module. The surveillance server module may be configured to function as a DNS server to map a domain name received from the portable device to an IP address of a default web page stored on the surveillance server module, and to provide the surveillance data and information related to the site to the portable device in response to receiving a request from the portable device.

The surveillance server module may be further configured to function as an HTTP server to cause the surveillance data to be presented to a user via a web browser on the portable device. The surveillance server module may be further configured to cause information related to the site to be presented by the portable device, where the information related to the site may include at least one of the following types of data: text, graphics, video and audio.

At least one of the communication module or the surveillance server module may be further configured to function as a DHCP server and additionally to provide DHCP option 6 to the portable device in response to receiving a DHCP address request from the portable device. At least one of the communication module or the surveillance server module may be further configured to support an NTP client to synchronize a clock in the communication module with a clock in the surveillance server module. At least one of the communication module or the surveillance server module further includes a GPS receiver to receive signals from a GPS satellite to provide time synchronization with the GPS satellite.

This summary is provided to introduce concepts relating to site surveillance for remote monitoring on portable devices. These techniques are further described below in the detailed description. This summary is not intended to identify essential features of the claimed subject matter, nor is it intended for use in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an exemplary site surveillance system for remote monitoring on portable devices in accordance with the present disclosure.

FIG. 2 illustrates another exemplary site surveillance system for remote monitoring on portable devices in accordance with the present disclosure.

FIG. 3 illustrates an exemplary user interface showing contents provided by a surveillance server module in accordance with the present disclosure.

FIG. 4 illustrates a process of site surveillance for remote monitoring on portable devices in accordance with the present disclosure.

FIG. 5 illustrates a block diagram of an illustrative computing device that may be used to enable site surveillance for remote monitoring on portable devices in accordance with the present disclosure.

### DETAILED DESCRIPTION

### Overview

The present disclosure describes a system and techniques for site surveillance for remote monitoring of live and stored audio/video data on portable devices. By enabling access to real-time and stored surveillance data via portable devices, it is believed that the issues described above can be alleviated. In particular, by using an embodiment of the disclosed surveillance system, one can wirelessly access real-time surveillance data of a site without having to know the whereabouts of or be physically close to display equipment connected to CCTV cameras of the surveillance system. In addition to real-time and stored surveillance data, the disclosed surveillance system can also provide information related to the site so that those with access to the surveillance system need not have prior knowledge of detailed information of the site, such as floor plan, structural design, emergency contact information, etc.

While aspects of described techniques relating to site surveillance for remote monitoring on portable devices can be implemented in any number of different computing systems, environments, and/or configurations, embodiments are described in context of the following exemplary system architecture(s).

### Illustrative First Exemplary Site Surveillance System

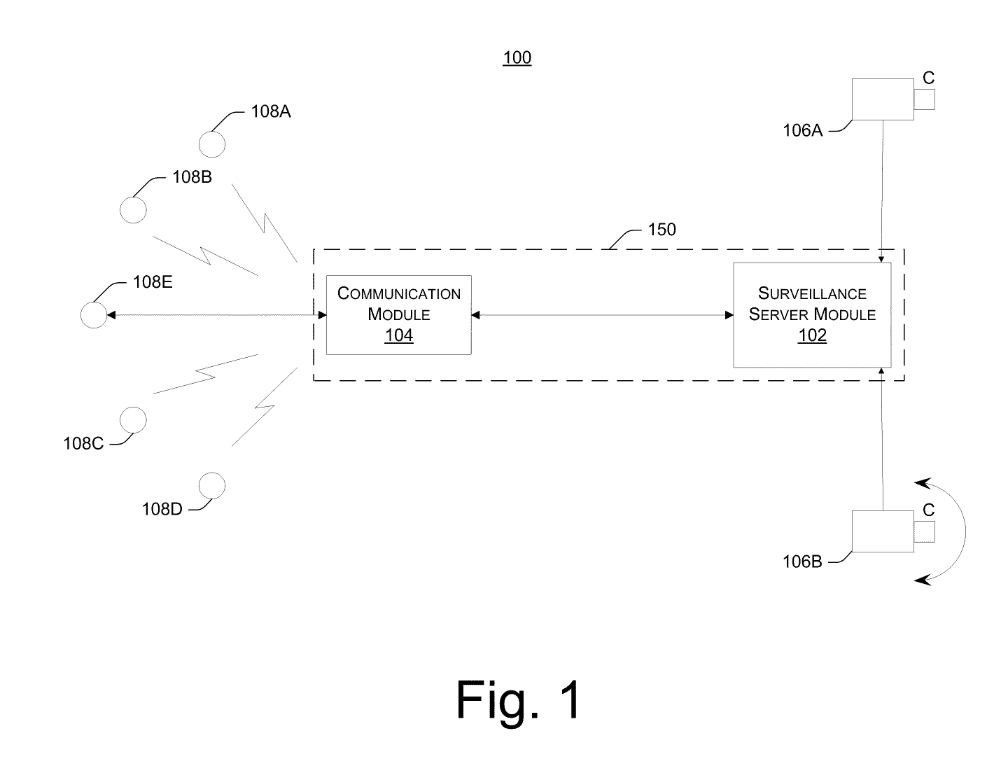

FIG. 1 illustrates an exemplary site surveillance system 100 for remote monitoring on portable devices in accordance with one embodiment. The system 100 includes a surveillance server module 102, a communication module 104 communicatively coupled to the surveillance server module 102, and one or more data capture modules 106A-B communicatively coupled to the surveillance server module 102. Although two data capture modules, 106A and 106B, are shown in FIG. 1 for illustrative purposes, other embodiments of the system 100 may have only one data capture module or more than two data capture modules. Additionally, although only one communication module, namely the communication module 104, is shown in FIG. 1, in other embodiments the surveillance system 100 may have multiple communication modules (not shown) communicatively coupled to the surveillance server module 102. In one embodiment, the multiple communication modules may form a mesh network and thereby enabling a greater range of wireless accessibility of the surveillance system 100 and thus the surveillance data. In one embodiment, each of the surveillance server module 102, communication module 104, and data capture modules 106A-B is physically separate from one another. In other embodiments, some or all of the surveillance server module 102, communication module 104, and data capture modules 106A-B are physically implemented in a single device but are described separately below in view of the distinct functionality of each. For example, in one embodiment, the site surveillance module 102 and the communication module 104 are integral parts of a single device 150. In other embodiments, the site surveillance module 102 and the communication module 104 are physically separate devices.

Each of the data capture modules 106A-B is capable of capturing live video and/or audio data such as still images, video footage, sounds, or a combination thereof. In one embodiment, at least one of the data capture modules 106A-B is a surveillance camera such as a CCTV camera. In another embodiment, at least one of the data capture modules 106A-B is adjustable via the surveillance server module 102 in a number of aspects including pan, tilt, and zoom. That is, a user of the surveillance system 100 is able to adjust the pan, tilt, zoom, or a combination thereof, of either or both of the data capture modules 106A-B by sending control commands to the adjustable data capture module 106A and/or 106B through the surveillance server module 102. Upon capturing data, whether still images, video footage, sounds, or a combination thereof, the data capture modules 106A-B generate electronic signals that are representative of the captured data and received by the surveillance server module 102. In other words, the captured data can be viewed and/or listened to on a real-time basis by a user of the surveillance system 100, or the captured data can be stored by the surveillance system 100 for later viewing and/or listening by a user.

The communication module 104 is capable of establishing wireless communications with one or more portable devices, such as portable devices 108A-D. In one embodiment, the communication module 104 is a wireless access point. In another embodiment, the communication module 104 is a wireless router. The wireless communications between the communication module 104 and the portable devices 108A-D may be based on the Institute of Electrical and Electronics Engineers (IEEE) 802.11 standards, such as, for example, 802.11a, 802.11b, 802.11g, 802.11n, or a combination thereof. Alternatively or additionally, the wireless communications between the communication module 104 and the portable devices 108A-D may be based on other wireless communication standards such as, for example, IEEE 802.16 (WiMax), Long Term Evolution (LTE), any other applicable wireless communications protocol, or a combination thereof. The wireless communications between the communication module 104 and the portable devices 108A-D may be encrypted or unencrypted, such as by using the WEP (wired equivalent privacy) or WPA (Wi-Fi protected access) based protocol. If encrypted, users of the portable devices 108A-D will need to know the encryption protocol-specific security key to establish wireless communications with the communication module 104. Moreover, in order to establish wireless communications with the communication module 104, the portable devices 108A-D need to be within a certain range of distance from the communication module 104 in accordance with the pertinent wireless communication protocol in use.

Other than wireless communications, in one embodiment, the communication module 104 is able to establish wired communications with one or more portable devices, such as the portable device 108E. In one embodiment, the wired communications between the communication module 104 and the portable device 108E may be based on the IEEE 802.3 standards. Communication between the communication module 104 and the surveillance server module 102 may also be based on the IEEE 802.3 standards, the IEEE 802.11 standards, the IEEE 802.16 standards, LTE, any other applicable wireless communications protocol, or a combination thereof.

The communication module 104 serves as an electronic gateway between one network and another network; for example, between the surveillance system 100 and the portable devices 108A-E. The communication module 104 may be capable of performing tasks that are traditionally performed by various specific-purpose servers in a network. In one embodiment, the communication module 104 is configured to function as a DHCP server capable of providing dynamic IP addresses and additionally to provide DHCP option 6 to the portable devices 108A-E in response to receiving individual DHCP address requests from the portable devices 108A-E. Additionally or alternatively, the communication module 104 is configured to function as an HTTP server. For example, the communication module 104 may function as an HTTP server that redirects web traffic from the portable devices 108A-E to a home page on the communication module 104 or a home page on the surveillance server module 102. Additionally or alternatively, the communication module 104 is configured to support an NTP client to synchronize a clock in the communication module 104 with a clock in the surveillance server module 102, which is configured to support an NTP server.

Each of the portable devices 108A-D may be a laptop or notebook computer, a mobile phone, a smart phone, a personal digital assistant, or any portable computing device that is capable of establishing wireless communication with the communication module 104. Likewise, the portable device 108E may be a laptop or notebook computer, a mobile phone, a smart phone, a personal digital assistant, or any portable computing device that is capable of establishing wired communication with the communication module 104. Each of the portable devices 108A-E is installed with a web-based user interface application, such as a web browser, or alternatively a non-browser-based user interface application that can be used to present or display data received from the surveillance server module 102. Although all five portable devices 108A-E are shown in FIG. 1, the communication module 104 may be communicating with the portable devices 108A-E separately at different times or simultaneously. Moreover, although five portable devices 108A-E are shown in FIG. 1 for illustrative purposes, the communication module 104 is capable of simultaneously establishing communication with fewer or more portable devices.

The surveillance server module 102 receives the electronic signals from the data capture modules 106A-B as surveillance data. In one embodiment, the surveillance server module 102 is capable of providing the surveillance data for real-time access by a user. For example, the user may view and/or hear the captured live sight and sound through the surveillance server module 102. In another embodiment, the surveillance server module 102 is a digital video recorder (DVR) that stores the surveillance data for time-shifted access by a user at a later time. For example, the user may view and/or hear the sight and sound captured a period of time ago using an onboard HTTP server or other control mechanism. In yet another embodiment, the surveillance server module 102 is a DVR that is capable of both providing the surveillance data for real-time access and storing the surveillance data for time-shifted access by a user.

The surveillance server module 102 may be capable of performing tasks that are traditionally performed by various specific-purpose servers in a network. In one embodiment, the surveillance server module 102 is configured to function as a DNS server, an HTTP server, a DHCP server, or a combination thereof. When the surveillance server module 102 is configured to function as a DNS server, the surveillance server module 102 can map a domain name received from any of the portable devices 108A-E to an IP address of a default web page stored on the surveillance server module 102. When the surveillance server module 102 is configured to function as an HTTP server, the surveillance server module 102 can cause the surveillance data to be presented to a user via a web browser on one or more of the portable devices 108A-E. When the surveillance server module 102 is configured to function as a DHCP server capable of providing dynamic IP addresses, the surveillance server module 102 can provide DHCP option 6 to the portable devices 108A-E in response to receiving individual DHCP address requests from the portable devices 108A-E.

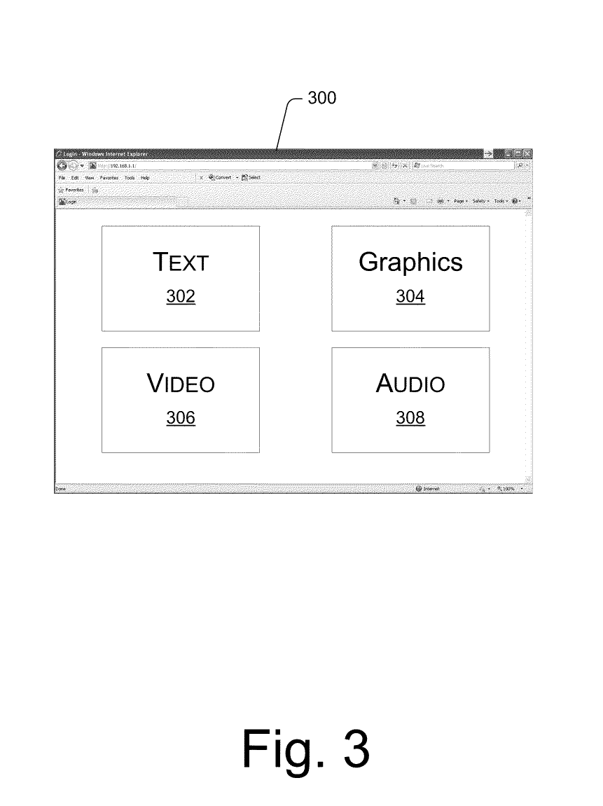

The default web page is a home page of the surveillance system 100. FIG. 3 illustrates an exemplary user interface, or a web page 300 showing contents provided by the surveillance server module 102 in accordance with one embodiment. The web page 300 represents the default web page, or home page, of the surveillance system 100 and any other web page that is navigable from the home page. A user of the surveillance system 100 can view and/or listen to real-time or time-shifted surveillance data from the web page 300. In addition to the surveillance data, in one embodiment, the surveillance server module 102 also provides information related to the site, such as floor plan, blue prints, emergency contact information, crisis management information, structural design, escape routes, pictures, texts, etc. As shown in FIG. 3, the information presented on the web page 300 may include at least one of the following types of data: text 302, graphics 304, video 306 and audio 308. That is, other than the surveillance data, which may be video, audio, or a combination thereof, the information related to the site that is presented on the web page 300 may be textual, graphical, video and/or audio.

In operation, one or more of the portable devices 108A-E connect to the communication module 104 via a pertinent communication protocol. The portable devices 108A-E in connection with the communication module 104 are then given DHCP option 6, domain-name-server in the DHCP offer, when requesting a DHCP address. The DHCP option 6 may be provided by the communication module 104 or the surveillance server module 102, depending on which one is functioning as a DHCP server. This causes domain name space lookup to be performed by the surveillance server module 102, which functions as a DNS server. As a result, when the web browser is opened up on the portable devices 108A-E, all the web traffic is automatically redirected to the home page of the surveillance server module 102, which also functions as an HTTP server, regardless what default page the web browser is configured to open. Accordingly, a user of one of the portable devices 108A-D can wirelessly access live surveillance data as well as information related to the site without knowing the whereabouts of, or being wired to, the surveillance server module 102 or the communication module 104.

Illustrative Second Exemplary Site Surveillance System

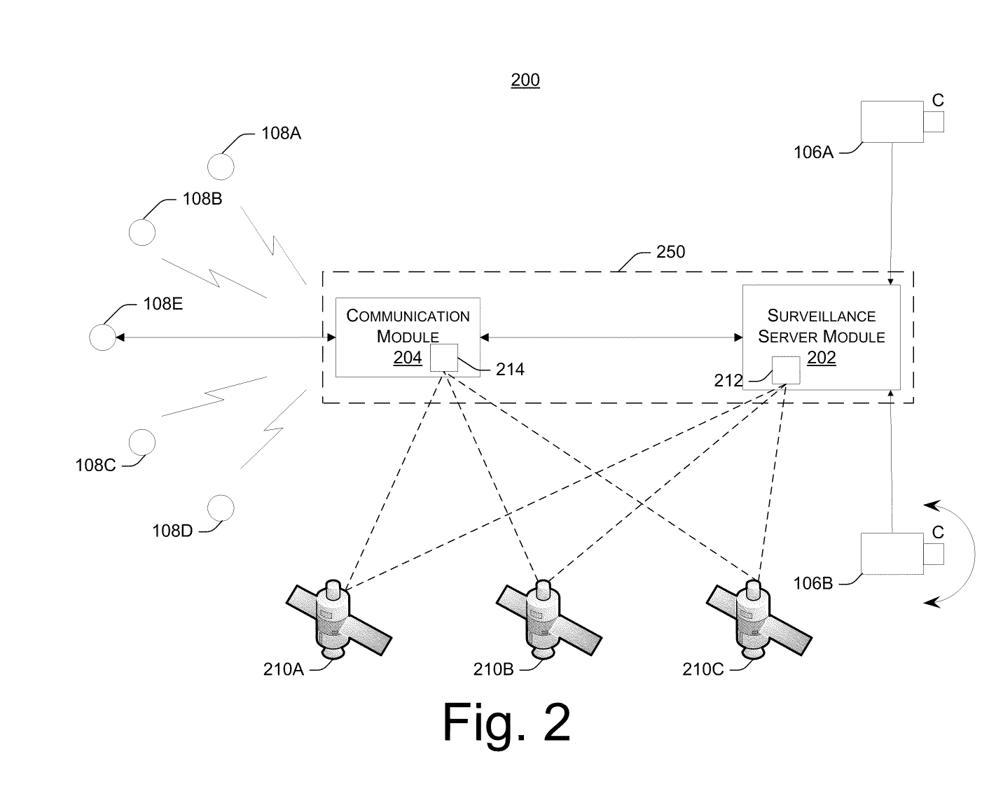

FIG. 2 illustrates another exemplary site surveillance system 200 for remote monitoring on portable devices in accordance with one embodiment. The system 200 includes a surveillance server module 202, a communication module 204 communicatively coupled to the surveillance server module 202, and one or more data capture modules 106A-B communicatively coupled to the surveillance server module 202. The communication module 204 is in communication with one or more of portable devices 108A-E. Although only one communication module, namely the communication module 204, is shown in FIG. 2, in other embodiments the surveillance system 200 may have multiple communication modules (not shown) communicatively coupled to the surveillance server module 202. In one embodiment, the multiple communication modules may form a mesh network and thereby enabling a greater range of wireless accessibility of the surveillance system 200 and thus the surveillance data. In the interest of brevity, similarity between system 100 of FIG. 1 and system 200 of FIG. 2 will not be described to avoid redundancy. In one embodiment, the site surveillance module 202 and the communication module 204 are integral parts of a single device 250. In other embodiments, the site surveillance module 202 and the communication module 204 are physically separate devices.

The surveillance server module 202 is equipped with a GPS receiver 212 to receive signals from one or more of the GPS satellites 210A-C to provide time synchronization with at least one of the GPS satellites 210A-C. This allows logging of authentication and other events as they occur on the surveillance server module 202. Similarly, the communication module 204 is equipped with a GPS receiver 214 to receive signals from one or more of the GPS satellites 210A-C to provide time synchronization with at least one of the GPS satellites 210A-C. This allows logging of authentication and other events as they occur on the communication module 204. Although three GPS satellites 210A-C are shown in FIG. 2 for illustrative purposes, the GPS receivers 212 and 214 can provide time synchronization with signals from fewer or more GPS satellites. Further, although FIG. 2 shows both the surveillance server module 202 and the communication module 204 are equipped with the GPS receiver 212 and 214, respectively, in one embodiment only one of the surveillance server module 202 and the communication module 204, but not the other, is equipped with the respective GPS receiver 212 or 214.

In one embodiment, either or both of the surveillance server module 202 and the communication module 204 are configured to support an NTP client and an NTP server. Accordingly, a clock in the communication module 204 and/or a clock in the surveillance server module 202 can be synchronized with an NTP server through GPS in accordance with the NTP. In another embodiment, either or both of the surveillance server module 202 and the communication module 204 are configured to be time synchronized with an external entity that is not part of the site surveillance system 200 using NTP and communication based on the IEEE 802.3 standards, the IEEE 802.11 standards, the IEEE 802.16 standards, or a combination thereof. For example, when an external server is somewhere on a network that the site surveillance system 200 has access to, such as via opened firewall port, etc., time synchronization between the external server and the surveillance server module 202 and/or the communication module 204 can be achieved at least for the purpose of sourcing time synchronization information. In such case, logging information can be written remotely to the external server with a time stamp synchronized with that of the surveillance server module 202 and/or the communication module 204.

### Illustrative Operations

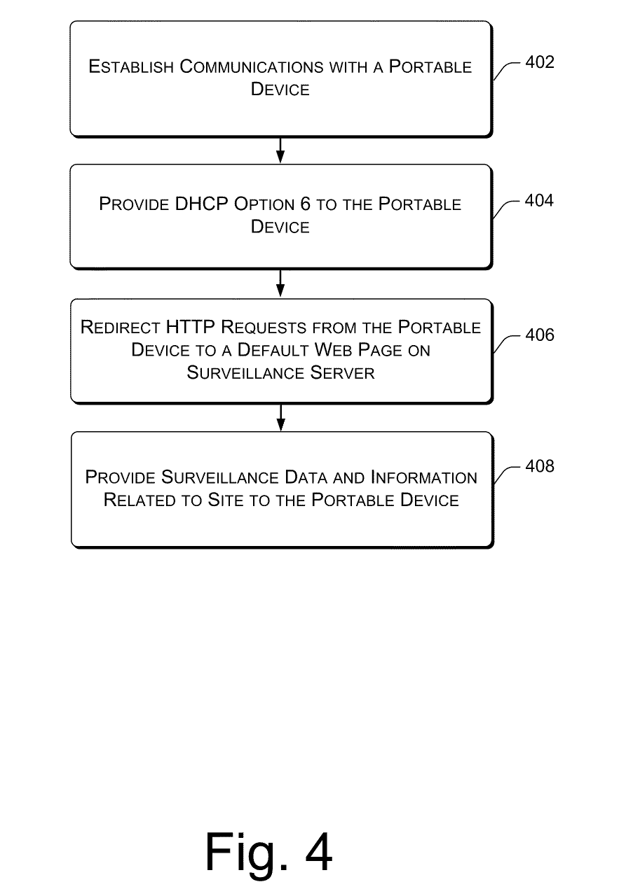

FIG. 4 illustrates a process 400 of site surveillance for remote monitoring in accordance with one embodiment. The process 400 begins at 402 with a portable device 108A-D establishing wireless communications with the communication module 104/204. Upon receiving a DHCP address request from the portable device 108A-D, either the communication module 104/204 or the surveillance server module 102/202, functioning as a DHCP server, provides DHCP option 6, in addition to the requested DHCP dynamic IP address, to the portable device 108A-D at 404. At 406, the surveillance server module 102/202, functioning as a DNS server, redirects all HTTP requests from the portable device 108A-D to a default web page stored on the surveillance server module 102/202. At 408, the surveillance server module 102/202, functioning as an HTTP server, provides the surveillance data and information related to the site to the portable device 108A-D as content of the default web page or any web page navigable from the default web page.

### Illustrative Computing Device

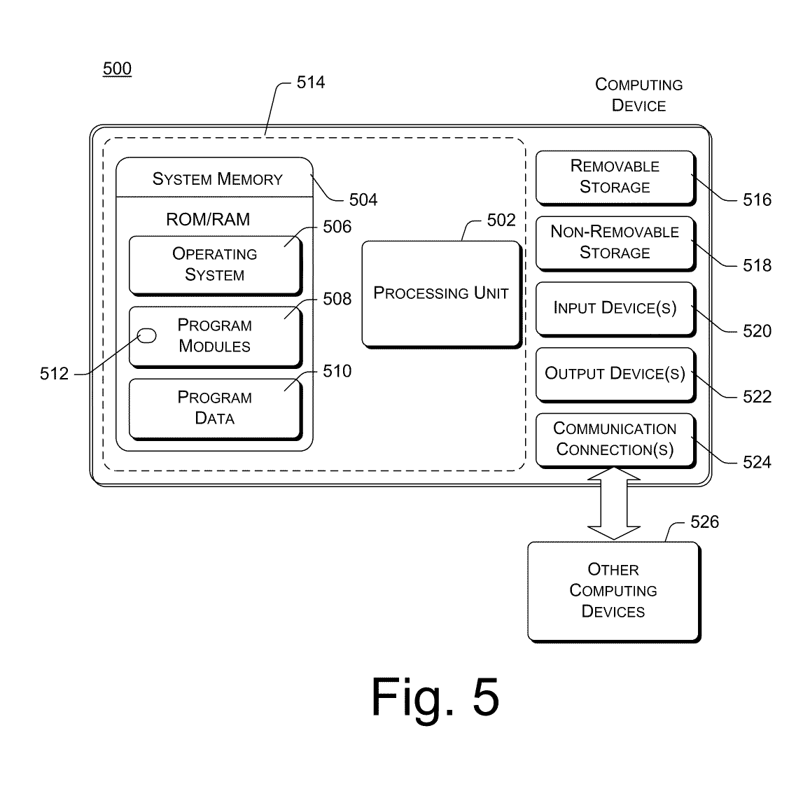

FIG. 5 illustrates a representative computing device 500 that may implement the techniques for site surveillance for remote monitoring on portable devices. However, it will be readily appreciated that the techniques disclosed herein may be implemented in other computing devices, systems, and environments. In one embodiment, the surveillance server module 102 of FIG. 1 and/or the surveillance server module 202 of FIG. 2 may be implemented with the computing device 500. The computing device 500 shown in FIG. 5 is only one example of a computing device and is not intended to suggest any limitation as to the scope of use or functionality of the computer and network architectures.

In at least one configuration, computing device 500 typically includes at least one processing unit 502 and system memory 504. Depending on the exact configuration and type of computing device, system memory 504 may be volatile (such as random-access memory, or RAM), non-volatile (such as read-only memory, or ROM, flash memory, etc.) or some combination thereof. System memory 504 may include an operating system 506, one or more program modules 508, and may include program data 510. The computing device 500 is of a very basic configuration demarcated by a dashed line 514. Again, a terminal may have fewer components but may interact with a computing device that may have such a basic configuration.

The program module 508 includes a site surveillance module 512. When the surveillance server module 102/202 is implemented with the computing device 500, the module 512 is configured to enable site surveillance for remote monitoring on portable devices. For example, the module 512 is capable of functioning as a DNS server, a DHCP server, and/or an HTTP server as described above with reference to FIG. 1 and FIG. 2. In one embodiment, the module 512 is configured to support a NTP client for time synchronization between the surveillance server module 102/202 and the communication module 104/204.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by removable storage 516 and non-removable storage 518. Computer storage media may include volatile and nonvolatile, removable and non-removable media implemented in any method or technology for storage of information, such as computer readable instructions, data structures, program modules, or other data. System memory 504, removable storage 516 and non-removable storage 518 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of the computing device 500. Computing device 500 may also have input device(s) 520 such as keyboard, mouse, pen, voice input device, touch input device, etc. Output device(s) 522 such as a display, speakers, printer, etc. may also be included.

Computing device 500 may also contain communication connections 524 that allow the computing device 500 to communicate with other computing devices 526, such as over a network which may include one or more wired networks as well as wireless networks. Communication connections 524 are some examples of communication media.

Communication media may typically be embodied by computer readable instructions, data structures, program modules, etc.

It is appreciated that the illustrated computing device 500 is only one example of a suitable device and is not intended to suggest any limitation as to the scope of use or functionality of the various embodiments described. Other well-known computing devices, systems, environments and/or configurations that may be suitable for use with the embodiments include, but are not limited to, personal computers (PCs), server computers, multiprocessor systems, microprocessor-base systems, network PCs, minicomputers, mainframe computers, distributed computing environments that include any of the above systems or devices, and/or the like.

### Conclusion

The above-described techniques pertain to site surveillance for remote monitoring of live and stored audio/video data on portable devices. Although the techniques have been described in language specific to structural features and/or methodological acts, it is to be understood that the appended claims are not necessarily limited to the specific features or acts described. Rather, the specific features and acts are disclosed as exemplary forms of implementing such techniques. Furthermore, although the techniques have been described in the context of site surveillance, the techniques may be applied in any other suitable context, such as surveillance of environmental conditions, for example.

What is claimed is:

1. A surveillance system to monitor a site, the system comprising:
a data capture module configured to capture images, sounds, or a combination thereof and to generate electronic signals representative of the captured images, sounds, or a combination of the captured images and sounds;
a communication module configured to establish wireless communication with a portable device; and
a surveillance server module communicatively coupled to the data capture module and the communication module, the surveillance server module configured to receive the electronic signals as surveillance data from the data capture module, receive a request from the portable device via the communication module, and cause the surveillance data to be presented to a user by the portable device in response to the request from the portable device.

2. The system of claim 1, wherein the data capture module comprises a video camera, and wherein the data capture module is adjustable via the surveillance server module in a number of aspects including pan, tilt, and zoom.

3. The system of claim 1, wherein the wireless communication is in accordance with the Institute of Electrical and Electronics Engineers (IEEE) 802.11 standards, the IEEE 802.16 standards, Long Term Evolution (LTE), or a combination thereof.

4. The system of claim 1, wherein the communication module is further configured to function as a Dynamic Host Configuration Protocol (DHCP) server and provide DHCP option 6 to the portable device in response to receiving a DHCP address request from the portable device.

5. The system of claim 1, wherein the communication module is further configured to support a Network Time Protocol (NTP) client to synchronize a clock in the communication module with a clock in the surveillance server module.

6. The system of claim 1, wherein the communication module includes a Global Positioning System (GPS) receiver to receive signals from a GPS satellite to provide time synchronization with the GPS satellite.

7. The system of claim 1, wherein the surveillance server module is communicatively coupled to the communication module in accordance with the Institute of Electrical and Electronics Engineers (IEEE) 802.3 standards, the IEEE 802.11 standards, the IEEE 802.16 standards, Long Term Evolution (LTE), or a combination thereof.

8. The system of claim 1, wherein the surveillance server module is a digital video recorder (DVR) that stores the surveillance data for time-shifted access by a user.

9. The system of claim 1, wherein the surveillance server module is further configured to function as a Dynamic Host Configuration Protocol (DHCP) server to assign an Internet Protocol (IP) address to the portable device.

10. The system of claim 1, wherein the surveillance server module is further configured to function as a Domain Name System (DNS) server to map a domain name received from the portable device to an Internet Protocol (IP) address of a default web page stored on the surveillance server module.

11. The system of claim 1, wherein at least one of the communication module or the surveillance server module is further configured to function as a Hypertext Transfer Protocol (HTTP) server to cause the surveillance data to be presented to the user via a web browser on the portable device.

12. The system of claim 1, wherein the surveillance server module is further configured to cause information related to the site to be presented by the portable device, the information related to the site including at least one of the following types of data: text, graphics, video and audio.

13. The system of claim 1, wherein the surveillance server module is further configured to support a Network Time Protocol (NTP) server to synchronize a clock in the surveillance server module with a clock in the communication module.

14. The system of claim 1, wherein the surveillance server module includes a Global Positioning System (GPS) receiver to receive signals from a GPS satellite to provide time synchronization with the GPS satellite.

15. A surveillance system to monitor a site, the system comprising:
a data capture module configured to capture images, sounds, or a combination thereof and to generate electronic signals representative of the captured images, sounds, or a combination of the captured images and sounds;
a communication module configured to establish wireless communication with a portable device; and
a surveillance server module communicatively coupled to receive the electronic signals as surveillance data from the data capture module and establish communication with the portable device via the communication module, the surveillance server module configured to function as a Domain Name System (DNS) server to map a domain name received from the portable device to an Internet Protocol (IP) address of a default web page stored on the surveillance server module, the surveillance server module further configured to provide the surveillance data and information related to the site to the portable device in response to receiving a request from the portable device.

16. The system of claim 16, wherein at least one of the communication module or the surveillance server module is further configured to function as a Dynamic Host Configuration Protocol (DHCP) server and provide DHCP option 6 to the portable device in response to receiving a DHCP address request from the portable device.

17. The system of claim 16, wherein at least one of the communication module or the surveillance server module is further configured to function as a Hypertext Transfer Protocol (HTTP) server to cause the surveillance data to be presented to a user via a web browser on the portable device.

18. The system of claim 16, wherein at least one of the communication module or the surveillance server module is further configured to support a Network Time Protocol (NTP) client to synchronize a clock in the communication module with a clock in the surveillance server module.

19. The system of claim 16, wherein at least one of the communication module or the surveillance server module further includes a Global Positioning System (GPS) receiver to receive signals from a GPS satellite to provide time synchronization with the GPS satellite.

20. The system of claim 16, wherein the information related to the site includes at least one of the following types of data: text, graphics, video and audio.
